(19) United States
(12) Patent Application Publication
(10) Pub. No.: US 2026/0329023 A1
(43) Pub. Date: Oct. 22, 2026

(54) OPTICAL SUBSTRATE HAVING INTEGRATED ANTENNAS, AND SPECTROMETER COMPRISING SAME

(71) Applicants: UNIVERSITE GRENOBLE ALPES, Saint-Martin-d'Hères (FR); CENTRE NATIONAL DE LA RECHERCHE SCIENTIFIQUE, Paris (FR); INSTITUT POLYTECHNIQUE DE GRENOBLE, Grenoble (FR); UNIVERSITE SAVOIE MONT BLANC, Chambéry (FR)

(72) Inventors: Guillerme Martin, Chambéry (FR); Alain Morand, Grenoble (FR)

(73) Assignees: UNIVERSITE GRENOBLE ALPES, Saint-Martin-d'Hères (FR); CENTRE NATIONAL DE LA RECHERCHE SCIENTIFIQUE, Paris (FR); INSTITUT POLYTECHNIQUE DE GRENOBLE, Grenoble (FR); UNIVERSITE SAVOIE MONT BLANC, Chambéry (FR)

(21) Appl. No.: 19/113,113

(22) PCT Filed: Aug. 16, 2023
(86) PCT No.: PCT/EP2023/072610

§ 371 Date: Mar. 19, 2025

(30) Foreign Application Priority Data
Oct. 4, 2022 (FR) FR2210146

(51) Int. Cl. G02B 6/42; G01J 3/18

(52) U.S. Cl. CPC G02B 6/4204; G01J 3/18

(57) ABSTRACT

The optical substrate (1) has an integrated waveguide (2), at least one antenna (330) being formed in the optical substrate (1), the at least one antenna being formed by a plurality of nanoholes (341, 342, 343), at least one of the nanoholes (341, 342, 343) differing from the other nanoholes (341, 342, 343) by at least one of: its diameter, its spacing of the waveguide (2) in the height direction of the optical substrate (1), and its distance from an adjacent nanohole of the same antenna in the longitudinal direction of the optical substrate (1). The optical substrate can be integrated into a spectrometer or spectrometers.

### FIELD OF THE INVENTION

The present invention relates to the field of integrated optics, and more particularly relates to an optical substrate with integrated antennas and to a spectrometer comprising it.

### BACKGROUND ART

In the field of integrated optics, when it is wished to send guided light in a planar guided structure buried in or on the surface of an optical component to an optical detector, in particular of the infrared (IR) or video camera type, outside the optical component, in a direction close to the normal to the surface of the optical component, the light will naturally diverge from the emission point to the detection point. If several distinct sources are formed on the surface of the optical component and it is wished to associate each source with a different pixel or group of pixels of the optical detector the signal coming from these distinct sources will spread over several pixels. This induces at the optical detector superposition on a pixel (or group of pixels) of the signals from the different sources, creating crosstalk and reducing the signal-to-noise ratio. This large angular divergence is due to the source points, considered as pin points and therefore very divergent, and to the active zone in optical detectors (notably of the IR type), which can be several hundred micrometers below the physical surface of the optical detector.

A first solution to overcome these drawbacks is to space the source points. However, the density of information that can be processed is thus reduced.

Another solution is to act on the extraction of light from the waveguide to the optical detector. For example, a Bragg grating (physical alternation of high/low refractive index zones) can be used, placed on the surface of the waveguide. The greater the interaction between the guided mode and the Bragg grating, the greater the extracted signal intensity will be. This principle is widely known in integrated optics. Most solutions for improving the directivity of the radiated flux are thus based on two-dimensional antennas of the surface array type, by electron beam lithography, a focused ion beam, or polymerization. The following publications disclose such solutions:
3D optical YagiUda nanoantenna array, Dregely D. et al., Nat. Communications 2(1):1-7(2011),
Hybrid nanoantennas for directional emission enhancement, Rusak, E. et al., Appl. Phys. Lett., 105, 221109-1 to 221109-5 (2014),
Dielectric antennas-a suitable platform for controlling magnetic dipolar emission, Schmidt M. K. et al., Opt. Express 20(13): 13636-13650 (2012),
All-dielectric antenna wavelength router with bidirectional scattering of visible light, Li, J. et al., Nano Lett, 16, 4396-4403 (2016),
All Integrated Lithium Niobate Standing Wave Fourier Transform Electro-Optic Spectrometer, Loridat, J. et al., Journal of Lightwave Technology, 2018 Oct. 15; 36(20):4900-4907.

There are three-dimensional single-antenna solutions, similar to surface microlenses to that are relatively complex implement, as described in Broadband highly directive 3D nanophotonic lenses, Johlin, E. et al., Nature Communications 9, 1-8 (2018),
Improving the vertical radiation pattern issued from multiple nano-groove scattering centers acting as an antenna for future integrated optics Fourier transform spectrometers in the near IR, Morand, A. et al., Opt Lett. 2019, Feb. 1; 44(3):542-545.

However, the prior art Bragg grating is produced only in a planar manner, on the surface. It is then only possible to control the period or the duty cycle of the periods to control the extraction power of the grating.

Another possibility for manufacturing the Bragg grating is to make periodically spaced air nano “holes” (which resemble air cylinders) in the material constituting the component. Such a technique for forming nanoholes is for example described in the following publications:
High aspect ratio nanochannel machining using single shot femtosecond Bessel beams), Bhuyan, M. K. et al., Appl. Phys. Lett. 97, 081102-1 to 081102-3 (2010),
Single shot high aspect ratio bulk nanostructuring of fused silica using chirp controlled ultrafast laser Bessel beams, Bhuyan, M. K. et al., Appl. Phys. Lett. 104, 0201107-1 to 0201107-4 (2014),
Spatio-temporal dynamics in nondiffractive Bessel ultrafast laser nanoscale volume structuring, Velpula, P. K. et al., Las. Photon Rev. 10(2):230-244 (2016),
Near-infrared spectro-interferometer using femtosecond laser written GLS embedded waveguides and nano-scatterers, Martin, G. et al., Optics Express, 25(7):8386-8397 (2017).

According to these techniques, a non-diffractive irradiation procedure is used to photo-inscribe nanoholes in the optical substrate comprising a waveguide using focused Bessel beams that generate locally in the optical substrate a sufficient concentration of energy to create localized one-dimensional micro-explosions, the lateral pressure release creating one-dimensional axially uniform cavities, to create extended uniform nanoholes (sometimes called Bessel nanoholes). It is possible with this technique to use two lasers which face each other with the optical substrate in the middle, or a single laser aimed at the substrate.

The main interest of laser inscription for the production of elongated nanoholes is that it is possible to cover a sampling length of 1 cm without mask replacement in a very short time (a few seconds). Additionally, the position of the hole relative to the waveguide can be adjusted. The geometry and length of the nanoholes can be controlled “at will”, but with a compromise between length and diameter.

The production of air nanoholes using laser photo-inscription techniques, for example, makes it possible to produce this type of planar array. As with the two-dimensional antennas described above, only the period or duty cycle of the periods can be varied to control the extraction power of the array.

The publication Laser written 3D 3T spectro-interferometer: Study and optimisation of the laser written nano-antenna, Bonduelle, M. et al., in Optical and Infrared Interferometry and Imaging, Ed. Tuthill et al., Proceedings of SPIE, 11446, 114462T-1 to 114462T-13 (December 2020) describes the use of nanoholes for extraction of an optical flux in a waveguide.

### SUMMARY OF THE INVENTION

The present invention aims to optimize the extraction of an optical flux confined in a waveguide integrated in an optical substrate in order to direct it toward a detector located on the surface of the optical substrate integrating the waveguide using three-dimensional nano-antennas of the air nanohole type formed by laser photo-inscription.

Unlike classic lithographic technologies, which are surface techniques, it is in fact possible with the laser photo-inscription described above to produce a Bragg grating at any depth in an optical substrate integrating a waveguide, in particular allowing the diffracting structures and the waveguide to be protected from surface effects (scratches, dust, etc.). It is also envisaged according to the present invention to produce diffracting nanostructures by other techniques, for example in resins deposited above the waveguide: a photo-sensitive resin is deposited on a surface waveguide, then exposed with a laser, for example a UV laser (simpler than the femtosecond lasers of the laser photo-inscription technique), then degraded in the exposed places, which are then eliminated with a solvent to also form air nanoholes.

The approach according to the present invention using laser photo-inscription or other equivalent techniques to produce three-dimensional nanoantennas (typically 100 nm in diameter) is more versatile than the prior the art. The result is similar to three-dimensional stacks that can be produced in polymers by Microlight 3D® or Nanoscribe® tools, for example by two-photon absorption.

The nanoantennas are thus formed directly in the material in which the waveguide is located, without requiring an additional resin deposition step as in the case of Microlight 3D®.

The invention provides access to an additional degree of freedom. In fact, the nanoholes can be made at different heights relative to one another. The extraction of the optical flux from the waveguide by these three-dimensional antennas made of nanoholes can therefore be controlled by several parameters: the period, the duty cycle with the diameter of the nanoholes, the offset, spacing or superposition of periodic nanoholes in height.

This has the effect of reducing the angular emission cone, allowing the flux extracted from the waveguide to be directed toward a very reduced number of pixels of an associated optical detector. The divergence is then almost zero, regardless of the depth of the active zone in the optical detector, and the signal can be measured without crosstalk.

The invention thus makes it possible to control the power extracted with a two-dimensional array for a given number of nanoholes by controlling the vertical position of the array relative to the waveguide. The angular divergence of the radiation decreases with the number of nanoholes or the length of the array. The period of the nanoholes is in this case preferably λ/n, with λ the wavelength of the signal and n the refractive index of the substrate in which the waveguide and the nanoholes are formed.

To obtain a more homogeneous shape of the vertical radiation it may be possible to use an apodized grating. This apodization can be done in two ways: either by controlling the diameter of the nanoholes or by vertically shifting the position of the nanoholes.

Finally, when the period of the nanoholes is 2 to 3 times greater than λ/n, there are several radiated Bragg orders (i.e. several directions of light radiation in addition to the normal direction). It is also possible to distribute the nanoholes horizontally and vertically to reduce the influence of radiation in directions other than vertical.

The invention can thus make it possible to develop a compact optical spectrometer without any moving parts, the detector being bonded to the photon collector waveguide to be characterized with a Bragg grating as the only relay optics.

The present invention therefore relates to an optical substrate with an integrated waveguide, the optical substrate having a longitudinal direction, a transverse direction and a height direction and being made of a material with a refractive index n, the waveguide being formed in the optical substrate in the longitudinal direction of the optical substrate, at least one antenna being formed in the optical substrate offset from the waveguide in the height direction, the at least one antenna being configured to diffract, in the height direction of the optical substrate, an evanescent wave produced on the surface of the waveguide by a standing wave generated by the injection of an optical signal of wavelength λ into the waveguide, characterized in that the at least one antenna is formed by several nanoholes formed in the transverse direction of the optical substrate, at least one of the nanoholes differing from the other nanoholes by at least one of its diameter, its spacing from the waveguide in the height direction of the optical substrate and its spacing at an adjacent nanohole of the same antenna along the longitudinal direction of the optical substrate.

The distribution and/or apodization of nanoholes in the height direction makes it possible to improve the extraction of the flux from the waveguide to the outside of the substrate. According to one embodiment the at least one antenna comprises an odd number of nanoholes, preferably between three and five nanoholes, more preferably five nanoholes.

The width (angular flare) and intensity of the diffracted signal are related to the number of nanoholes: the more holes, the more coherent the signal, with a finer peak and less crosstalk. Thus, the signal intensity is proportional to the number of holes, the diffraction width being inversely proportional to the number of holes. Increasing the number of holes introduces constraints on repeatability. A compromise between signal coherence and repeatability is achieved with around five nanoholes per antenna.

The at least one antenna may be formed between the waveguide and the detector, in which case the at least one antenna diffracts the evanescent wave away from the waveguide, or the at least one antenna may be formed opposite the detector relative to the waveguide, in which case the at least one antenna diffracts the evanescent wave toward the waveguide and the detector.

The standing wave formed in the waveguide by the injection of an optical signal of wavelength λ can be obtained either by reflection at the end of the waveguide using a mirror or by injection of two sources on either side of the waveguide (therefore injection from the left and from the right of the waveguide simultaneously), which requires a prior division of the optical flux from the source to make a 50/50 distribution then a separation of the optical paths to inject by the two opposite inputs of the waveguide.

According to one embodiment, the nanoholes have diameters decreasing symmetrically from a central nanohole of the antenna to the end nanoholes.

A variable nanohole diameter (apodization) within the same antenna makes it possible to adjust the envelope of the diffracted signal. For example, a wider hole in the center of the antenna makes it possible to reduce the secondary lobes of the signal diffracted by the antenna to improve the quality of extraction of the signal diffracted toward the outside of the optical substrate, making it possible for example to pass from a diffracted signal having the shape of a cardinal sine to a Gaussian shape.

According to one embodiment, the nanoholes are in parallel planes along the height direction of the optical substrate.

According to one embodiment, the nanoholes have a V-shaped arrangement, the central nanohole constituting the tip of the V facing the waveguide and the other nanoholes being arranged symmetrically along each branch of the V in planes perpendicular to the height direction of the optical substrate moving away from the waveguide depending on whether the nanoholes they contain approach the ends of the branches of the V, the spacing separating two adjacent nanoholes when projected onto a plane perpendicular to the height direction of the optical substrate being equal to λ/n or to an integer multiple of λ/n. Within the same antenna, the spacing separating each pair of adjacent nanoholes may be the same, but the invention is not limited in this regard, the spacings within the same antenna being able to differ provided that each spacing separating two adjacent nanoholes when projected onto a plane perpendicular to the height direction of the optical substrate is equal to λ/n or to an integer multiple of λ/n.

According to one embodiment, the at least one antenna comprises five nanoholes having a W-shaped arrangement and arranged in two planes parallel to each other and perpendicular to the height direction of the optical substrate, a first plane comprising the central nanohole and the two end nanoholes, the distance between each end nanohole and the central nanohole along the longitudinal direction of the optical substrate in the first plane being equal to a characteristic distance equal to λ/n or to an integer multiple of λ/n, a second plane arranged between the waveguide and the first plane comprising the two other nanoholes spaced apart by a distance equal to the characteristic distance along the longitudinal direction of the optical substrate, the first plane and the second plane being separated by half the characteristic distance along the height direction of the optical substrate.

The characteristic distance is preferably equal to λ/n, but can also take the value of an integer multiple of λ/n.

According to one embodiment the optical substrate comprises several antennas formed on the same side of the waveguide in the height direction and constituting an antenna array, the antenna array being configured to diffract one or more wavelengths.

The various antennas formed in the optical substrate can thus either be formed, in the height direction of the optical substrate, between the waveguide and the detector, or opposite the detector relative to the waveguide, the waveguide then being between the antennas and the detector.

The present invention also has for object a spectrometer comprising a light source, an optical substrate as defined above and a detector, the substrate having two opposite parallel flat faces in the height direction of the optical substrate, the light source being configured to inject light into the waveguide of the optical substrate, the detector being arranged opposite the flat face of the substrate towards which the light diffracted by the at least one antenna is directed.

Light injection can be effected using an optical fiber bonded to the substrate, facing the waveguide, or using microlenses bonded to the waveguide, or by focusing the beam coming from the light source with microscope objectives or any suitable optical lens assembly.

According to one embodiment, fluid reservoirs are formed on the surface of the optical substrate, on the face of the optical substrate facing the detector, in order to allow spectrometric analysis of the light diffracted by the at least one antenna and passing through the reservoirs.

According to one embodiment, a microfluidic circuit is formed between the detector and the face of the optical substrate facing the detector, in order to allow spectrometric analysis of the light diffracted by the at least one antenna and passing through the microfluidic circuit.

### BRIEF DESCRIPTION OF THE DRAWINGS

To better illustrate the subject of the present invention, embodiments, given for illustrative and non-limiting purposes, will now be described with reference to the accompanying drawings.

In these drawings:

FIG. 1 is a sectional view of a prior art optical substrate integrating a waveguide;

FIG. 2 is a schematic view of a prior art antenna;

FIG. 3 is a view similar to FIG. 2 of an antenna according to a first embodiment of the present invention;

FIG. 4 is a curve illustrating the differences in performance between an antenna according to the prior art technique and an antenna according to the first embodiment;

FIG. 5 is a view similar to FIG. 2 of an antenna according to a second embodiment of the present invention;

FIG. 6 is a view similar to FIG. 2 of an antenna according to a third embodiment of the present invention;

FIG. 7 is a curve illustrating the differences in performance between an antenna according to the prior art and an antenna according to the third embodiment of the invention; and

FIG. 8 is a schematic representation of a spectrometer according to the invention integrating an antenna according to a fourth embodiment of the invention.

### DETAILED DESCRIPTION OF PARTICULAR EMBODIMENTS

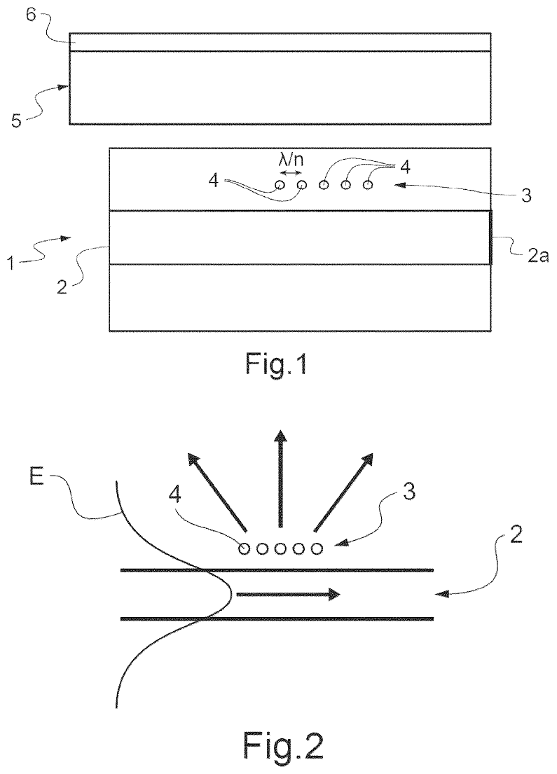

Referring to FIG. 1, it can be seen that a prior art optical substrate 1 with integrated waveguide has been shown.

In FIG. 1, the longitudinal direction of the optical substrate 1 is the left-to-right direction of FIG. 1, the height direction is the top-to-bottom direction of FIG. 1, and the transverse direction is the direction perpendicular to the plane of FIG. 1.

The optical substrate 1 is a material of refractive index n and comprises an integrated waveguide 2 formed along the longitudinal direction of the optical substrate 1. Waves enter the integrated waveguide 2 from the left of FIG. 1 and are reflected by a mirror 2a formed at the right end of the integrated waveguide 2 to form inside the integrated waveguide 2 a standing wave with the propagating wave and the contrapropagating wave generated by the mirror 2a, the evanescent wave resulting from this standing wave being diffracted toward an antenna 3 formed of several nanoholes 4 (five nanoholes 4 in FIG. 1 spaced λ/n apart, λ being the wavelength of the optical signal injected into the waveguide 2 in the form of tubes which extend in the transverse direction of the optical substrate 1.

As can be seen in FIG. 1, the term nanohole refers to a nanoscale hole that is formed inside the substrate, i.e. within the thickness of the optical substrate 1. A nanohole is therefore completely enveloped by material at least in the height direction and in the longitudinal direction. A nanohole is not a surface structuring or indentation formed on the surface of the optical substrate 1. A nanohole may have a circular section in a plane perpendicular to the transverse direction. Each nanohole can be filled with vacuum, air, or even any material with a refractive index different from the refractive index of the optical substrate 1.

Each nanohole can be made using a focused laser beam, for example. The focused laser beam is configured to create micro-explosions that cause material compression leading to the formation of nanoholes. By modifying the laser power, the refractive index can also be locally modified to obtain an index contrast large enough to generate diffraction (for example by locally rendering the initial material amorphous).

Alternatively, nanoholes could also be produced using a two-part substrate: the surface of a first part could be etched before being covered by the second part of the substrate.

The antenna 3 samples a point of the propagating wave by converting the evanescent part of the propagating wave interacting with the nanoholes 4 into a vertical radiated wave to vertically extract a part of the propagating wave, the same behavior being obtained for the contrapropagating wave. The waves diffracted by the antenna 3 are extracted towards a detector 5 on the upper part of which a layer of optical sensors 6 is formed. The sum of the two waves radiated on the optical sensor layer 6 makes it possible to generate interference which will in this case be contrasted. By way of non-limiting example, the detector may be made of InP, the optical sensor layer 6 in the upper part being an array of IngaAs pixels.

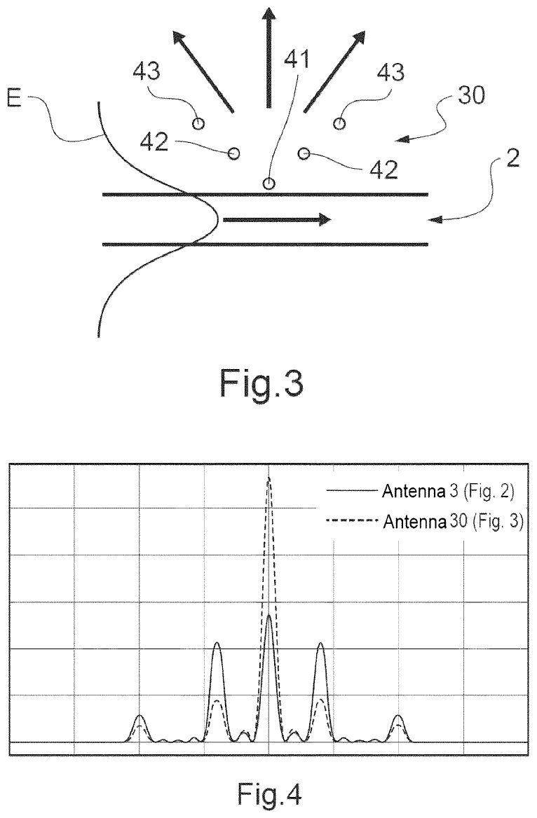

It should be noted that there is in FIG. 1 an air space between the optical substrate 1 and the detector 5, but that such an air space is not necessarily mandatory, the detector 5 being able to be bonded to the surface of the optical substrate 1. Furthermore, an anti-reflection layer may be provided on the face of the detector 5 facing the optical substrate 1. FIG. 2 represents the antenna 3 of FIG. 1 more schematically, represented only in relation to the waveguide 2 with the optical substrate 1 and the detector 5 of FIG. 1 omitted for greater readability of the drawing, composed of five nanoholes 4 arranged in the same plane in the height direction of the optical substrate, the nanoholes 4 of the antenna 3 having the same dimensions and diffusing the evanescent wave from the incident optical wave E in the left part of the integrated waveguide 2 and moving therein as shown by the arrow represented in the waveguide 2 from left to right, toward the detector (not shown in FIG. 2).

FIG. 3 is a view similar to FIG. 2 of an antenna 30 according to a first embodiment of the invention in which the nanoholes 41, 42, 43 are arranged in a V, with the tip of the V constituted by the nanohole 41 closest to the integrated waveguide 2 and the other nanoholes 42, 43 extending symmetrically in the height direction of the optical substrate 1 toward the detector (also not shown in FIG. 3). As shown in FIG. 3, the antenna 30 comprises five nanoholes 41, 42, 43, the first nanohole 41 constituting as indicated the tip of the V at a first height relative to the optical waveguide 2, two nanoholes 42 in the same plane located at a second height relative to the optical waveguide 2 greater than the first height, and two nanoholes 43 in the same plane located at a third height relative to the optical waveguide 2 greater than the second height and constituting the ends of the branches of the V formed by the antenna 30. Note that the height of a nanohole can be defined as the distance separating the center of a nanohole from the optical waveguide 2. Regardless of their height, all the nanoholes nevertheless remain distant from the surface of the optical substrate 1 opposite the detector 5.

The spacing between two nanoholes can be defined as the distance separating the center of these two nanoholes. Two adjacent nanoholes 41, 42, 43 in FIG. 3 are spaced 2λ/n in the longitudinal direction and 2λ/n in the height direction. The invention is not limited in this regard, however. So, to make it bigger for size reasons, if the lateral separation between two holes in the same plane is K*λ/n, with K a natural integer, then the vertical separation will have to be K*2λ/n.

FIG. 4 shows the difference in performance between antenna 3 in FIG. 2 and antenna 30 in FIG. 3 by representing the shape of the radiation obtained above each antenna (wavelength on the abscissa axis and intensity on the ordinate axis), the solid curve representing the performance of the antenna 3 in FIG. 2 and the dashed curve representing the performance of the antenna 30 in FIG. 3. FIG. 4 thus shows an improvement in the extraction cone and a reduction in secondary peaks, and therefore better performance of the antenna 30 in terms of reduction of crosstalk between neighboring pixels of a detector facing the antenna.

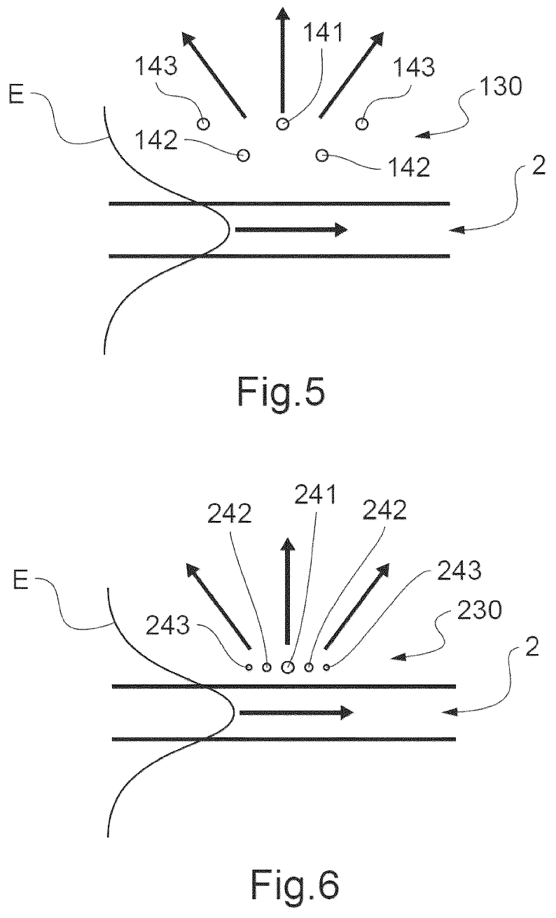

FIG. 5 is a view similar to FIG. 2 of an antenna 130 according to a second embodiment of the invention in which the nanoholes 141, 142, 143 are configured in a W shape with two nanoholes 142 in a first plane and three nanoholes 141, 143 in a second plane parallel to the first plane and farther from the waveguide 2 than the first plane, the nanoholes 141, 142, 143 in each plane being spaced apart by λ/n, the two planes being spaced by λ/(2n), each nanohole 142 of the first plane being arranged, in orthogonal projection onto the waveguide 2, at the centers of two nanoholes 141, 143 of the second plane. As before, however, the invention is not limited in this regard. So, if it is wished to make it bigger for size reasons, if the lateral separation between two holes in the same plane is K*λ/n, with K a natural integer, then the vertical separation will have to be K*2λ/n.

FIG. 6 is a view similar to FIG. 2 of an antenna 230 according to a third embodiment of the invention in which the nanoholes 241, 242, 243 are arranged in the same plane at a certain distance from the waveguide 2 in the height direction of the substrate.

The difference between the nanoholes 241, 242, 243 in the antenna 230 of this third embodiment results from apodization: the nanoholes 241, 242, 243 have different diameters, the central nanohole 241 having the largest diameter, the two adjacent nanoholes 242 having a diameter smaller than that of the central nanohole 241 and the two end nanoholes 243 having a diameter even smaller than that of the nanoholes 242.

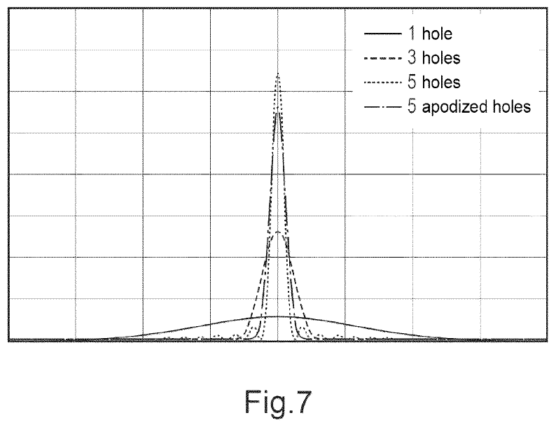

The effect of apodization is shown in FIG. 7, representing the shape of the radiation obtained above each antenna (wavelength on the abscissa axis and intensity on the ordinate axis). In particular, the dotted curve represents an antenna 3 according to FIG. 2 and the light gray curve represents an antenna 230 according to the third embodiment in FIG. 6. Apodization allows a significant reduction of secondary peaks, once again reducing the crosstalk effect on neighboring pixels of a detector placed opposite the antenna. FIG. 7 also shows the effect of the extraction cone improvement as a function of the increasing number of nanoholes in the antenna (1 nanohole corresponds to the solid curve with a very flattened extraction cone, 3 nanoholes correspond to the dashed line curve with a more pronounced extraction cone, the best extraction cone being obtained with five nanoholes (dotted curve), the five apodized holes having a less pronounced extraction cone but more attenuated sidelobes than the antenna with 5 holes without apodization). Generally speaking, since the nanoholes are buried in the optical substrate, symmetry of the optical medium around the nanoholes is obtained. The flux extracted from the waveguide thus has symmetry properties which make it possible to increase the optical flow diffracted toward the pixels, and therefore to improve the signal-to-noise ratio. The association of several nanoholes makes it possible to reduce the angular cone emission, making it possible to direct the flux extracted from the waveguide toward a very reduced number of pixels of an associated optical detector.

Although the antenna 3 of the various embodiments is shown in the Figures between the waveguide 2 and the detector 5, without departing from the scope of the present invention the antenna 3 could also be formed in the optical substrate 1 under the waveguide 2, namely opposite the detector 5 with respect to the waveguide 2.

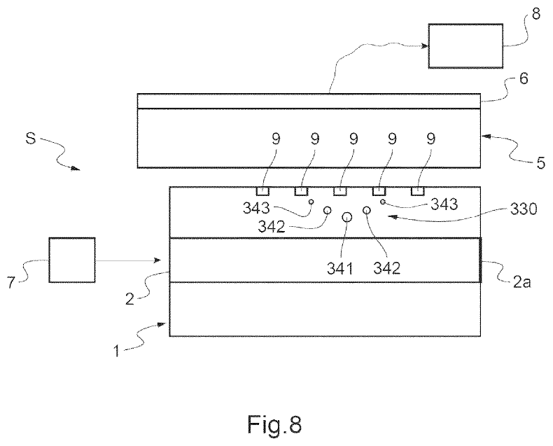

It is also to be clearly understood that the invention is not limited in its various embodiments with regard to the generation of the standing wave and that the standing wave could be created in the waveguide 2 by any other means, in the absence of the mirror 2a at the end of the waveguide 2 opposite the end of injection of the optical signal, for example by injection of two optical sources on either side of the waveguide 2 (therefore injection from the left and from the right of the waveguide 2 simultaneously), with a prior division of the optical flux from the source to obtain a 50/50 distribution on the two sources, then separation of the optical paths to inject the signals from the two optical sources created by the two opposite inputs of the waveguide 2. Referring now to FIG. 8, it can be seen that there is shown a spectrometer S according to the present invention.

As in FIG. 1, the spectrometer S according to the present invention comprises an optical substrate 1 with an integrated waveguide 2 having a mirror 2a at its end opposite the optical wave input end, an optical source 7 and a signal processing device 8.

An antenna 330 according to a fourth embodiment is formed in the optical substrate 1, above the waveguide 2 in the height direction of the optical substrate 1, the antenna 330 being a combination of the first and third embodiments, namely consisting of five nanoholes 341, 342, 343, formed in a V shape as in the first embodiment and apodized as in the third embodiment, the central nanohole 341 being the larger diameter nanohole which constitutes the base of the V, the other nanoholes 342 and 343 being arranged above and having smaller diameters in the direction away from the waveguide 2. The optical signal emitted by the optical source 7 in the waveguide 2 generates by circulating in the waveguide 2 an evanescent wave directed by the antenna 330 toward the detector 5 and in particular toward the pixel array schematically represented by the layer 6 in the upper part of the detector 5, the resulting signals being sent to the signal processing device 8. The signal processing device 8 may be a microprocessor, a microcontroller, a processor, a digital signal processor (DSP), a field-programmable gate array (FPGA), an application-specific component (ASIC), or even a computer with software enabling processing and analysis of the signals emitted by the pixels of layer 6.

Thus, an optical wave injected into the waveguide 2 by the optical source 7 forms an evanescent wave diffracted by the antenna 330 to be captured by the pixels 6 and then processed by the signal processing device 8 to form the optical spectrometer S. Alternatively, fluid circulation channels 9 may be formed on the surface of the optical substrate 1 and connected to a fluid circulation device (not shown in FIG. 7) to circulate in the channels 9 a fluid to be analyzed by the spectrometer S according to the invention by analyzing the influence of the fluid on the optical wave captured by the pixels 6 of the detector 5.

It is to be understood that the antenna according to the invention has been shown schematically in the Figures but that its dimensions are not necessarily to scale, in relation to the dimensions either of the optical substrate 1 or of the waveguide 2. Also, it is contemplated according to the invention that there may be more or fewer nanoholes per antenna, several antennas per optical substrate/spectrometer to capture different wavelengths, and different antenna configurations, provided that at least one of the diameter, the spacing of the waveguide in the height direction of the optical substrate and the spacing between two adjacent nanoholes varies for the nanoholes of the same antenna.

1. An optical substrate comprising an integrated waveguide,
the optical substrate having a longitudinal direction, a transverse direction and a height direction and being made of a material with a refractive index n,
the waveguide being formed in the optical substrate in the longitudinal direction of the optical substrate,
at least one antenna being formed in the optical substrate offset from the waveguide in the height direction,
wherein the at least one antenna is configured to diffract in the height direction of the optical substrate an evanescent wave produced on the surface of the waveguide by a standing wave generated by injection of an optical signal of wavelength λ into the waveguide,
wherein the at least one antenna is formed by several nanoholes formed in the transverse direction of the optical substrate, and
wherein at least one of the nanoholes differing from the other nanoholes by at least any one of diameter, spacing from the waveguide in the height direction of the optical substrate, and spacing from an adjacent nanohole of the antenna in the longitudinal direction of the optical substrate.

2. The optical substrate as claimed in claim 1, wherein the at least one antenna comprises an odd number of nanoholes.

3. The optical substrate as claimed in claim 2, wherein the nanoholes have diameters decreasing symmetrically from a central nanohole of the antenna toward an end nanoholes.

4. The optical substrate as claimed in claim 1, wherein the nanoholes are in parallel planes in the height direction of the optical substrate.

5. The optical substrate as claimed in claim 4, wherein
the at least one antenna comprises an odd number of nanoholes, and
the nanoholes have an arrangement in a shape of a V, the central nanohole constituting the tip of the V being opposite the waveguide and the other nanoholes being arranged symmetrically along each branch of the V in planes perpendicular to the height direction of the optical substrate in a direction away from the waveguide depending on whether the nanoholes that they contain approach the ends of the branches of the V, the spacing separating two adjacent nanoholes, when projected onto a plane perpendicular to the height direction of the optical substrate, being equal to λ/n or an integer multiple of λ/n.

6. The optical substrate as claimed in claim 4, wherein
the at least one antenna comprises an odd number of nanoholes, and
the at least one antenna comprises five nanoholes having an arrangement in a shape of a V, and arranged in two planes parallel to each other and perpendicular to the height direction of the optical substrate, a first plane comprising a central nanohole and two end nanoholes, a distance between each end nanohole and the central nanohole in the longitudinal direction of the optical substrate in the first plane being equal to a characteristic distance equal to λ/n or to an integer multiple of λ/n, a second plane arranged between the waveguide and the first plane comprising the two other nanoholes spaced by a distance equal to a characteristic distance in the longitudinal direction of the optical substrate, the first plane and the second plane being separated by half the characteristic distance along the height direction of the optical substrate.

7. The optical substrate as claimed in claim 1, wherein the optical substrate comprises several antennas formed on a same side of the waveguide in the height direction and constituting an antenna array, the antenna array being configured to diffract one or more wavelengths.

8. A spectrometer comprising:
a light source,
an optical substrate as claimed in claim 1, and
a detector,
wherein the optical substrate has two parallel plane faces opposite in the height direction of the optical substrate,
wherein the light source is configured to inject light into the waveguide of the optical substrate, and
wherein the detector is arranged opposite a flat face of the optical substrate towards which light diffracted by the at least one antenna is directed.

9. The spectrometer as claimed in claim 8, wherein fluid reservoirs are formed on a surface of the optical substrate, on a face of the optical substrate facing the detector, in order to allow spectrometric analysis of light diffracted by the at least one antenna and passing through the reservoirs.

10. The spectrometer as claimed in claim 8, wherein a microfluidic circuit is formed between the face of the optical substrate facing the detector and the detector, in order to allow a spectrometric analysis of light diffracted by the at least one antenna and passing through the microfluidic circuit.

11. The spectrometer as claimed in claim 9, wherein a microfluidic circuit is formed between the face of the optical substrate facing the detector and the detector, in order to allow a spectrometric analysis of light diffracted by the at least one antenna and passing through the microfluidic circuit.

12. The optical substrate as claimed in claim 2, wherein the at least one antenna comprises a number of nanoholes comprised in a range of from three to five.

13. The optical substrate as claimed in claim 12, wherein the at least one antenna comprises five nanoholes.

14. The optical substrate as claimed in claim 12, wherein the nanoholes have diameters decreasing symmetrically from a central nanohole of the antenna toward an end nanoholes.

15. The optical substrate as claimed in claim 13, wherein the nanoholes have diameters decreasing symmetrically from a central nanohole of the antenna toward an end nanoholes.

16. The optical substrate as claimed in claim 2, wherein the nanoholes are in parallel planes in the height direction of the optical substrate.

17. The optical substrate as claimed in claim 3, wherein the nanoholes are in parallel planes in the height direction of the optical substrate.

18. The optical substrate as claimed in claim 5, wherein the nanoholes have diameters decreasing symmetrically from a central nanohole of the antenna toward an end nanoholes.

19. The optical substrate as claimed in claim 6, wherein the nanoholes have diameters decreasing symmetrically from a central nanohole of the antenna toward an end nanoholes.

20. The optical substrate as claimed in claim 2, wherein the optical substrate comprises several antennas formed on a same side of the waveguide in the height direction and constituting an antenna array, the antenna array being configured to diffract one or more wavelengths.
